(19) United States
(12) Patent Application Publication
(10) Pub. No.: US 2025/0044596 A1
(43) Pub. Date: Feb. 6, 2025

(54) IMAGE DISPLAY APPARATUS

(71) Applicant: CANON KABUSHIKI KAISHA, Tokyo (JP)

(72) Inventor: Masakazu TOHARA, Tokyo (JP)

(21) Appl. No.: 18/743,168

(22) Filed: Jun. 14, 2024

(30) Foreign Application Priority Data
Aug. 2, 2023 (JP) 2023-126004

(51) Int. Cl. G02B 27/01; G02B 27/28

(52) U.S. Cl. CPC G02B 27/0172; G02B 27/286; G02B 2027/0118; G02B 2027/0136; G02B 2027/0178

(57) ABSTRACT

An image display apparatus includes right-eye and left-eye display elements, each of which has a plurality of pixels on a display surface, and right-eye and left-eye display optical system configured to guide image light from the right-eye and left-eye display element to right and left eyes of an observer. Each of the right-eye and left-eye display elements includes an element that is at least one of a color filter and a microlens provided corresponding to each pixel. An intersection of an optical axis of each of the right-eye and left-eye display optical systems and the display surface shifts from a center of the display surface. In each of the right-eye and left-eye display elements, a shift amount of a center of the element from a center of the pixel in a peripheral area is larger than that in an intersection area.

### BACKGROUND

### Technical Field

One of the aspects of the embodiments relates to an image display apparatus such as a head mount display (HMD) configured to guide light from a display element to an observer's eyes to enable magnified images to be observed.

### Description of Related Art

Some of the image display apparatuses described above enable images to be observed at a wide angle of view by displaying images at different angles of view for the observer's left and right eyes. The image display apparatus disclosed in Japanese Patent Laid-Open No. 2012-242794 displays images at different angles of view for the left and right eyes by laterally reversing optical systems in which an outer angle of view is wider than an inner angle of view. The image display apparatus disclosed in Japanese Patent Laid-Open No. 6-38246 displays images at different angles of view for the left and right eyes by shifting the display centers of the left-eye and right-eye display elements in the left and right directions, respectively, and by shifting the images displayed on respective display elements in the left and right directions viewed from the observer.

In an attempt to reduce a focal length of the optical system for a wider angle of view and a reduced thickness of the image display apparatus, an exit angle of light from a peripheral area of a display element increases, and a luminance decrease and a chromaticity shift are likely to occur in an image. Thus, in a case where the observer observes the peripheral area, a bright and correct colored image cannot be observed.

However, Japanese Patent Laid-Open Nos. 2012-242794 and 6-38246 are silent about a method for reducing the chromaticity shift in the peripheral area of the display element.

### SUMMARY

An image display apparatus according to one aspect of the disclosure includes a right-eye display element and a left-eye display element, each of which has a plurality of pixels on a display surface, a right-eye display optical system configured to guide image light from the right-eye display element to a right eye of an observer, and a left-eye display optical system configured to guide image light from the left-eye display element to a left eye of the observer. Each of the right-eye display element and the left-eye display element includes an element that is at least one of a color filter and a microlens provided corresponding to each of the plurality of pixels. An intersection of an optical axis of the right-eye display optical system and the display surface of the right-eye display element shifts from a center of the display surface of the right-eye display element. An intersection of an optical axis of the left-eye display optical system and the display surface of the left-eye display element shifts from a center of the display surface of the left-eye display element. In a case where an area including the intersection is set to an intersection area and an area on a peripheral side of the intersection area is set to a peripheral area, in each of the right-eye display element and the left-eye display element, a shift amount toward a peripheral side of a center of the element corresponding to the pixel from a center of the pixel in the peripheral area is larger than that in the intersection area.

Further features of various embodiments of the disclosure will become apparent from the following description of embodiments with reference to the attached drawings.

### BRIEF DESCRIPTION OF THE DRAWINGS

FIG. 1 illustrates the configuration of an image display apparatus according to Example 1.

FIG. 2 explains a display optical system according to Example 1.

FIG. 3 is an external view of the image display apparatus according to Example 1.

FIGS. 4A and 4B illustrate an angle-of-field characteristic of the display element according to Example 1.

FIGS. 5A to 5C explain a color filter according to Example 1.

FIGS. 6A and 6B illustrate an angle-of-field characteristic at an end in a horizontal direction of a display element according to Example 1.

FIG. 7 illustrates a relationship between a display angle of view and an exit angle from the display element according to Example 1.

FIGS. 8A and 8B explain the color filter according to Example 1.

FIG. 9 illustrates the configuration of an image display apparatus according to Example 2.

FIG. 10 illustrates the detailed configuration of a display optical system according to Example 2.

FIG. 11 illustrates the display optical system according to Example 2.

FIGS. 12A to 12C explain a color filter according to Example 2.

FIGS. 13A and 13B illustrate an angle-of-field characteristic at an end in a horizontal direction of a display element according to Example 2.

FIG. 14 illustrates a ghost optical path of the display optical system according to Example 2.

FIG. 15 illustrates a gate position in the display optical system according to Example 2.

FIGS. 16A and 16B illustrate an example in which a pixel pitch of a display element and a color filter pitch are different in Example 1.

FIG. 17 illustrates an example in which a color filter pitch is different between a binocular area and a monocular area according to Example 1.

### DESCRIPTION OF THE EMBODIMENTS

Referring now to the accompanying drawings, a detailed description will be given of embodiments according to the disclosure.

### Example 1

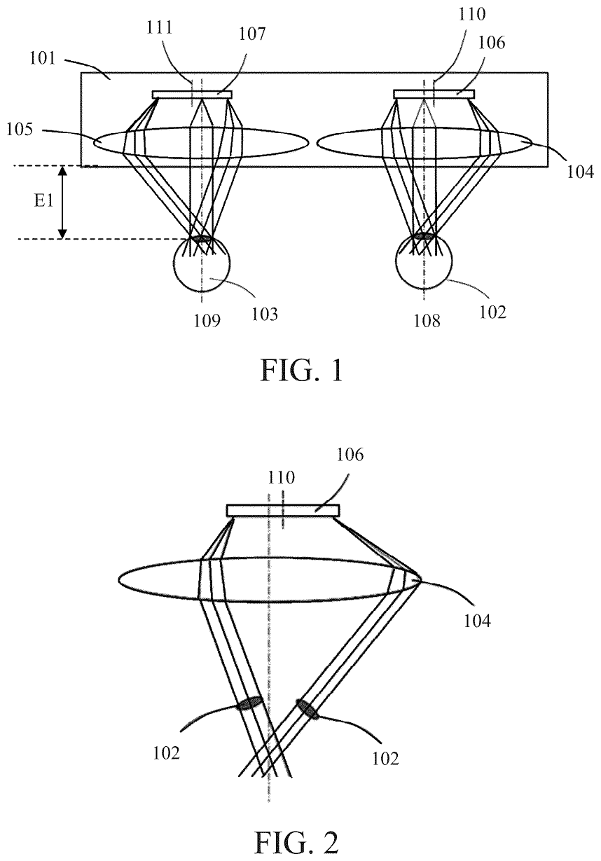

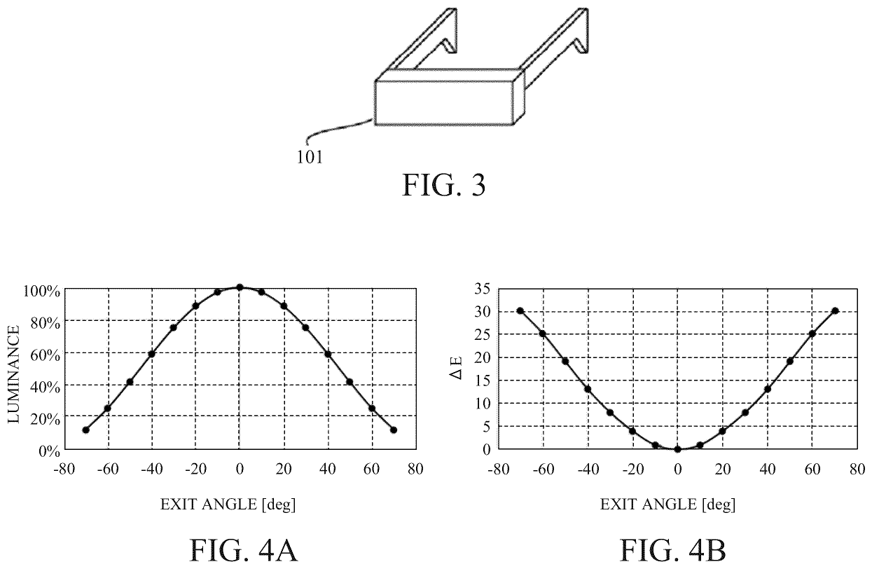

FIG. 1 illustrates the configuration of an HMD 101 as an image display apparatus according to Example 1. Reference numeral 102 denotes the observer's right eye, and reference numeral 103 denotes the observer's left eye. A right-eye lens 104 constitutes a right-eye display optical system, and a left-eye lens 105 constitutes a left-eye display optical system. Reference numeral 106 denotes a right-eye display element, and reference numeral 107 denotes a left-eye display element. Each display element includes an organic EL display, a liquid crystal display element, a digital micromirror device, or the like. Reference numeral 108 denotes an optical axis of the right-eye display optical system, and reference numeral 109 denotes an optical axis of the left-eye display optical system. Directions in which the optical axes 108 and 109 extend will be referred to as optical axis directions of the right-eye display optical system and the left-eye display optical system, respectively. Reference numeral 110 denotes a center of the display surface of the right-eye display element 106, and reference numeral 111 denotes a center of the display surface of the left-eye display element 107.

The right-eye display optical system guides image light from the right-eye display element 106 to the observer's right eye 102 so that the observer can observe as a display image an enlarged virtual image of an original image displayed on the right-eye display element 106. The left-eye display optical system guides image light from the left-eye display element 107 to the observer's left eye 103 so that the observer can observe as a display image an enlarged virtual image of an original image displayed on the left-eye display element 107.

A focal length F1 of each of the right-eye display optical system and the left-eye display optical system is 15 mm, and the size of each of the right-eye display element 106 and the left-eye display element 107 is 0.8 inch. An eye relief E1, which is a distance between the HMD 101 and each of the observer's eyeballs (102 and 103), is 15 mm. The HMD 101 is a head mount type image display apparatus, and the eye relief may be 15 mm or more so that even an observer wearing glasses can wear it. In a case where the eye relief is too long, the external shape of each display optical system and the HMD 101 become large, so the eye relief may be 25 mm or less. An exit pupil of each display optical system is set at a position of 25 mm, which is the sum of the eye relief of 15 mm and a radius of rotation of the eyeball of 10 mm, and an exit pupil diameter is set to 6 mm. Due to this setting, even in a case where the eyeball rotates to observe up, down, left, and right, image light in that direction enters the eyeball.

The center 110 of the right-eye display element 106 is shifted to the right with respect to a vertical section (a section perpendicular to the paper plane of FIG. 1) including the optical axis 108 of the right-eye display optical system. A horizontal display angle of view in the lateral (left-right) direction of the right-eye display optical system is 40° on the right side and 20° on the left side. The center 111 of the left-eye display element 107 is shifted to the left with respect to a vertical section including the optical axis 109 of the left-eye display optical system. A horizontal display angle of view in the left-right direction of the left-eye display optical system is 20° on the right side and 40° on the left side. That is, the right-eye display optical system and the left-eye display optical system have different left and right display angles of view with respect to the optical axis.

Therefore, when the observer observes images with both eyes (102 and 103), the angle of view from 40° on the right side to 20° on the right side is observed only with the right eye 102. In addition, the angle of view from 20° on the right side to 20° on the left side is observed with both eyes. Moreover, the display angle of view from 20° on the left side to 40° on the left side is observed only with the left eye 103. That is, the entire horizontal angle of view is 80°. Thus, in this example, images with different display angles of view are displayed for the right eye 102 and left eye 103, and parts of these display angles of view overlap each other and are displayed for both eyes. Thereby, in a case where the right-eye and left-eye display elements 106 and 107 have the same sizes, the observer can observe images at wider angles of view than those in a case where images with the same display angle of view are displayed for the right eye 102 and the left eye 103. The vertical display angle of view of each display optical system is 40°. In the following description, a display angle of view observed by only one of the right eye and the left eye will be referred to as a monocular area, and a display angle of view observed by both eyes will be referred to as a binocular area.

As described above, in a case where images with different display angles of view are displayed for the right and left eyes and parts of the display angles of view (binocular area) are displayed for both eyes for a wider angle of view, the display angle of view displayed for both eyes may be 40° or more. A display angle of view displayed for both eyes smaller than 40° reduces a three-dimensionally observable range and prevents a natural image from being observed.

In the case of a long eye relief, a short focal length, and a reduced thickness as in the display optical system (lenses 104 and 105) according to this example, the exit angle of the image light from the peripheral area (peripheral angle of view) of the display element increases. In a case where the exit angle from the display element is large, the angle-of-field characteristic deteriorates (luminance decreases or chromaticity shift in the peripheral area increases).

In the display optical system according to this example, as illustrated in FIG. 1, while the observer is looking at the front, the exit angle of the principal ray at the maximum peripheral angle of view of 40° from the display elements 106 and 107 in the horizontal direction is 35°, and the exit angle of the principal ray at the angle of view of 20° is 10°. The principal ray is a ray that passes through the center of the exit pupil of the display optical system. As illustrated in FIG. 2, while the observer is looking at the horizontal end of the display element 106, the exit angle of the principal ray at the maximum peripheral angle of view of 40° from the display element 106 in the horizontal direction is 55°, and the exit angle of the principal ray at an angle of view of 20° is 30°.

The luminance (brightness) and chromaticity shift (ΔE) of a normal display element under this condition are as illustrated in FIGS. 4A and 4B, respectively. As the exit angle from the display element increases, the luminance decreases, and the chromaticity shift increases.

Accordingly, this example changes the pixel pitch of the display element and the pitch of the color filters as spectroscopic elements provided for each pixel (pitch between the spectroscopic elements) using the intersection of the display surface of the display element and the optical axis of the display optical system as a center. Thereby, the center position of the color filter can be shifted from the pixel center in the peripheral area of the display element. That is, in the peripheral area of the display element, the color filter is shifted relative to the pixel in the direction of the exit angle of the image light. Thereby, the angle-of-field characteristic can be improved. At this time, in the peripheral area, since the image light is emitted outward from the optical axis of the display optical system, the color filter pitch is set larger than the pixel pitch. In other words, an angle (shift amount) of the outward shift for shifting the color filter center to the outside as the peripheral side from the pixel center is larger in the peripheral area on the periphery side of the intersection area than in the intersection area where the intersection of the display surface of the display element and the optical axis of the display optical system is located.

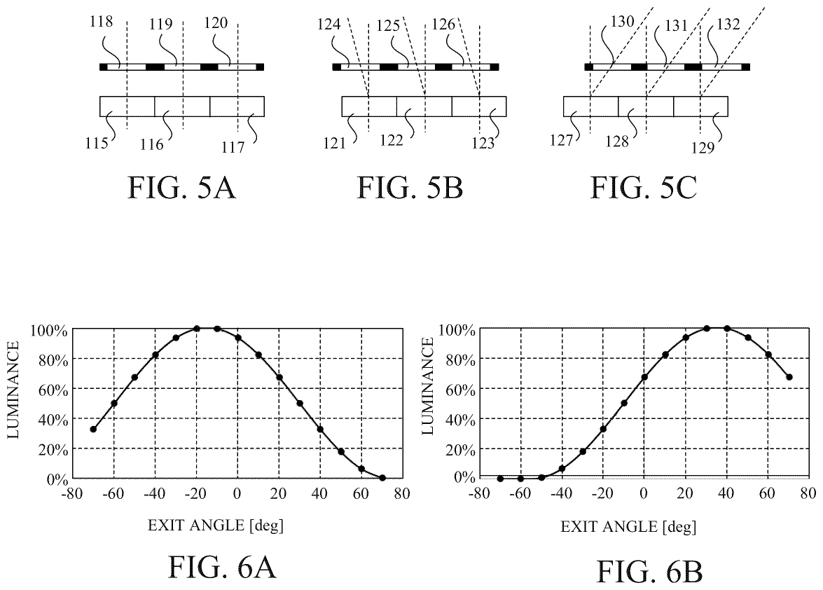

FIGS. 5A to 5C illustrate a positional relationship between red, green, and blue subpixels provided on the display surface of the right-eye display element 106 and red, green, and blue color filters. Each color filter may be rectangular, square, or hexagonal when viewed from the optical axis direction of the right-eye display optical system.

FIG. 5A illustrates the positional relationship at the intersection between the display surface of the right-eye display element 106 and the optical axis 108 of the right-eye display optical system. At (the intersection area including) the intersection, the centers of the red, green, and blue color filters 118, 119, and 120 coincide with the centers of the red, green, and blue subpixels 115, 116, and 117, respectively, as in a normal display element. FIG. 5B illustrates the positional relationship at the left end of the display surface of the right-eye display element 106 when viewed from the observer. At the left end, the centers of red, green, and blue color filters 124, 125, and 126 are shifted outward (towards the left eye side) by 15° from the centers of the red, green, and blue subpixels 121, 122, and 123, respectively. FIG. 5C illustrates the positional relationship at the right end of the display surface of the right-eye display element 106 when viewed from the observer. At the right end, the centers of the red, green, and blue color filters 130, 131, and 132 are shifted outward (opposite to the left eye side) by 35° from the centers of the red, green, and blue subpixels 127, 128, and 129, respectively.

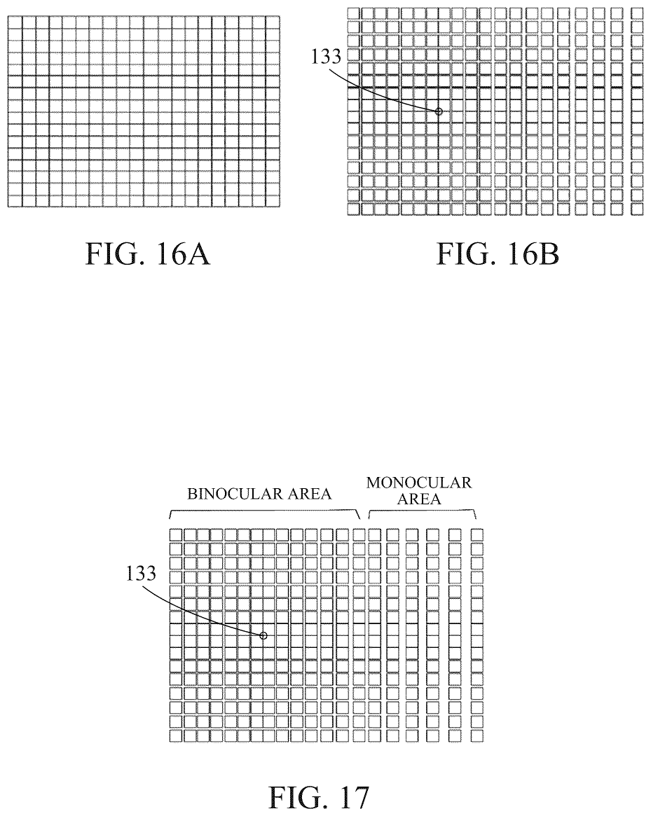

FIG. 16A illustrates an array of pixels (red, green, and blue subpixels are collectively illustrated as one pixel) on the display element when viewed from the optical axis direction of the display optical system. FIG. 16B illustrates an array of color filters when viewed from the optical axis direction. Reference numeral 133 denotes an intersection of the display surface of the display element and the optical axis of the display optical system. As illustrated in FIG. 16B, while the color filter size is maintained, the color filter pitch, that is, the shift amount from the pixel, increases from the intersection 133 to the peripheral area (from a portion on the intersection side to a portion on the peripheral side in the peripheral area).

In a case where the center of the display surface of the display element shifts from the optical axis of the display optical system as in this example, the principal ray is emitted from the display element in the normal direction, not from the center of the display surface but from the intersection of the display surface and the optical axis of the display optical system. Therefore, the angle-of-field characteristic can be improved by aligning the pixel center with the color filter center at the intersection.

The angle-of-field characteristic representing the luminance at the left end of the right-eye display element 106 at this time is as illustrated in FIG. 6A, in which the highest luminance is obtained in the −15° direction. Regarding the angle-of-field characteristic of the chromaticity shift, the highest characteristic (smallest chromaticity shift) is obtained in the −15° direction.

The exit angle of the principal ray from the left end of the right-eye display element 106 to the right-eye display optical system is −10° while the observer is looking at the front, and −30° while the observer is looking at the left end. Regarding the sign of the exit angle, the normal direction of the right-eye display element 106 is set to 0°, the right direction viewed from the observer is set positive, and the left direction viewed from the observer is set negative.

At the left end of the displayed image while the observer is looking at the front, unless the color filter is shifted relative to the pixel, the luminance decreases by 3% and ΔE becomes 1 as illustrated at −10° in FIGS. 4A and 4B, respectively. On the other hand, in a case where the color filter is shifted relative to the pixel, the luminance improves because luminance decreases only by 1%, as illustrated at −10° in FIG. 6A, and ΔE does not change, although it is not illustrated. At the left end of the displayed image while the observer is looking at the left end, unless the color filter is shifted relative to the pixel, the luminance decreases by 25% and ΔE becomes 8 as illustrated at −30° in FIGS. 4A and 4B. On the other hand, in a case where the color filter is shifted relative to the pixel, the luminance improves because luminance decreases only by 7%, as illustrated at −30° in FIG. 6A, and ΔE also improves to 2, although it is not illustrated.

The angle-of-field characteristic of the luminance at the right end of the right-eye display element 106 when viewed from the observer is as illustrated in FIG. 6B, in which the highest luminance is obtained in the 35° direction. Regarding the angle-of-field characteristic of the chromaticity shift, the highest characteristic is similarly obtained in the 35° direction.

The exit angle of the principal ray from the right end of the right-eye display element 106 to the right-eye display optical system is 35° while the observer is looking at the front, and 55° while the observer is looking at the right end.

At the right end of the displayed image while the observer is looking at the front, unless the color filter is shifted relative to the image, the luminance decreases by 33% and ΔE becomes 11 as illustrated at 35° in FIGS. 4A and 4B, respectively. On the other hand, in a case where the color filter is shifted relative to the image, the luminance does not decrease as illustrated at 35° in FIG. 6B, and ΔE does not increase although it is not illustrated. In addition, at the right end of the displayed image while the observer is looking at the right end of the displayed image, unless the color filter is shifted relative to the pixel, the luminance decreases by 67% and ΔE becomes 22, as illustrated at 55° in FIGS. 4A and 4B. On the other hand, in a case where the color filter is shifted relative to the pixel, the luminance decreases only by 12%, as illustrated at 55° in FIG. 6B, and ΔE also improves to 4, although it is not illustrated.

While the color filter shifts at the left and right ends in the horizontal direction of the display element have been described, this is similarly applicable to the upper and lower ends in the vertical direction. In the display optical system according to this example, while the observer is looking at the front, the exit angle of the principal ray from the display element with a maximum peripheral angle of view in the vertical direction of 20° is 10°. While the observer is looking at the end in the vertical direction, the exit angle of the principal ray from the display element with a maximum peripheral angle of view in the vertical direction of 20° is 30°.

At the upper end of the right-eye display element 106 when viewed from the observer, the center of the red color filter is placed at a position shifted upward by 15° from the center of the red subpixel. At the lower end of the right-eye display element 106, the center of the red color filter is placed at a position shifted downward by 15° from the center of the red subpixel. This is similarly applicable to the green color filter and the blue color filter.

Shifting the color filter from the pixel as described above can improve luminance and chromaticity shift at the upper and lower ends of the right-eye display element 106.

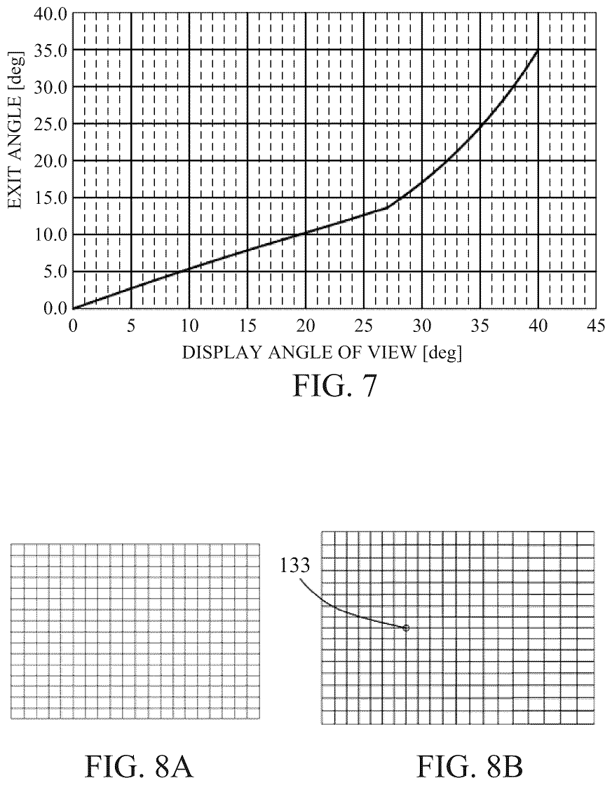

FIG. 7 illustrates a relationship between the display angle of view while the observer is looking at the front in the right-eye display optical system and the exit angle of the principal ray from the right-eye display element 106 in this example. As understood from FIG. 7, the exit angle of the principal ray from the right-eye display element 106 increases as the display angle of view increases. Therefore, it is necessary to increase the angle for shifting the color filter from the pixel from the intersection of the display surface of the right-eye display element 106 and the optical axis of the right-eye display optical system to the peripheral area.

In this case, since a shift amount of the color filter from the pixel increases from the intersection of the display surface and the optical axis to the peripheral area, the size of the color filter may be increased in accordance with the shift amount. Similarly to FIG. 16A, FIG. 8A illustrates a pixel array on the display element viewed from the optical axis direction. FIG. 8B illustrates the array and size of the color filters viewed from the optical axis direction. Similarly to FIG. 16B, reference numeral 133 denotes an intersection of the display surface of the display element and the optical axis of the display optical system. As illustrated in FIG. 8B, both the pitch and size of the color filters increase from the intersection 133 to the peripheral area. As the color filter size increases, an angle of image light that is emitted from the subpixel and transmits through the color filter increases, so that the angle-of-field characteristic is further improved.

The following inequality may be satisfied:

$$0 < φ \leq θ1 \qquad ( 1 )$$

where φ is an angle for shifting the color filter outward at a pixel A other than the intersection of the display surface of the display element and the optical axis of the display optical system (a tilt angle in a specific direction relative to a normal direction of the display surface), and θ1 is an exit angle of a principal ray from the display surface while the observer is looking at a display angle-of-view direction corresponding to pixel A, and a direction toward the outside of the display surface is set as positive. In other words, where pixel A is located at the end of the display surface, θ1 is an exit angle of a principal ray from the display surface that travels from an end to the center of the exit pupil while the observer's eyeball faces the end of the display surface.

In this example, θ1 at a display angle of 40° is 55°, θ1 at a display angle of 20° is 30°, and the angle φ for shifting the color filter outward in each pixel satisfies inequality (1).

In a case where the angle by which the color filter is shifted outward is 0° or less, that is, the angle-of-field characteristic is good in the normal direction or in the direction toward the inside of the display surface, a difference between the exit angle from the peripheral area of the display surface and the direction in which the angle-of-field characteristic is good is large. In this case, the luminance decrease and chromaticity shift in the peripheral area of the displayed image increase, and the observer cannot observe a natural image. Furthermore, in a case where the angle by which the color filter is shifted outward is larger than 01, a difference between the exit angle from the peripheral area of the display surface while the observer is looking at the front and the direction in which the angle-of-field characteristic is good is large. In this case, the luminance decrease and the chromaticity shift in the peripheral area of the displayed image increase while the observer is looking at the front, and the observer cannot observe a natural image.

The following inequality (2) may be satisfied:

$$θ2 \leq φ \leq θ1 \qquad ( 2 )$$

where θ2 is an exit angle of the principal ray from the display element in a direction of the display angle of view corresponding to pixel A while the observer is looking at the front, which is the optical axis direction of the display optical system, and is positive in a direction toward the outside. In a case where pixel A is located at the end of the display surface, θ2 is an exit angle of a principal ray from the display surface, which travels from the end of the display surface to the center of the exit pupil while the observer's eyeball faces the optical axis direction of the display optical system.

In this example, θ2 at a display angle of 40° is 35°, θ2 at a display angle of 20° is 10°, and the angle q for shifting the color filter outward in each pixel satisfies inequality (2).

In a case where the maximum display angle of view is 40° as in this example, the observer can recognize an image in the peripheral area while he is looking at the front, and thus an angle for shifting the color filter outward may be determined based on a state in which the observer is looking at the front.

As understood from FIG. 7, an increasing way of the exit angle from the display element is different between the binocular area with the display angle of view from 0° to 20° and the monocular area with the display angle of view from 20° to 40°, and an increase rate in the exit angle in the monocular area is larger than that in the binocular area. Therefore, the color filter pitch in the monocular area relative to the binocular area may be changed in accordance with the difference in the increase rate in the exit angle. In this case, as illustrated in FIG. 17, this example can improve the angle-of-field characteristic according to the exit angle for each of the monocular area and the binocular area by making the color filter pitch (that is, a shift amount relative to a pixel) in the monocular area larger than the color filter pitch in the binocular area.

FIG. 13 illustrates the appearance of the HMD 101. Since the HMD 101 is a head mount type image display apparatus, it may have a reduced weight. Thus, the lenses 104 and 105 in the display optical system may be made of resin, which has a lower specific gravity than that of glass. The aberration correction effect may be enhanced by using resin lenses 104 and 105 having aspheric surfaces on both sides.

In this example, each of the right-eye display optical system and the left-eye display optical system includes a single lens (104, 105), but each display optical system can include a plurality of lenses to achieve higher optical performance.

### Example 2

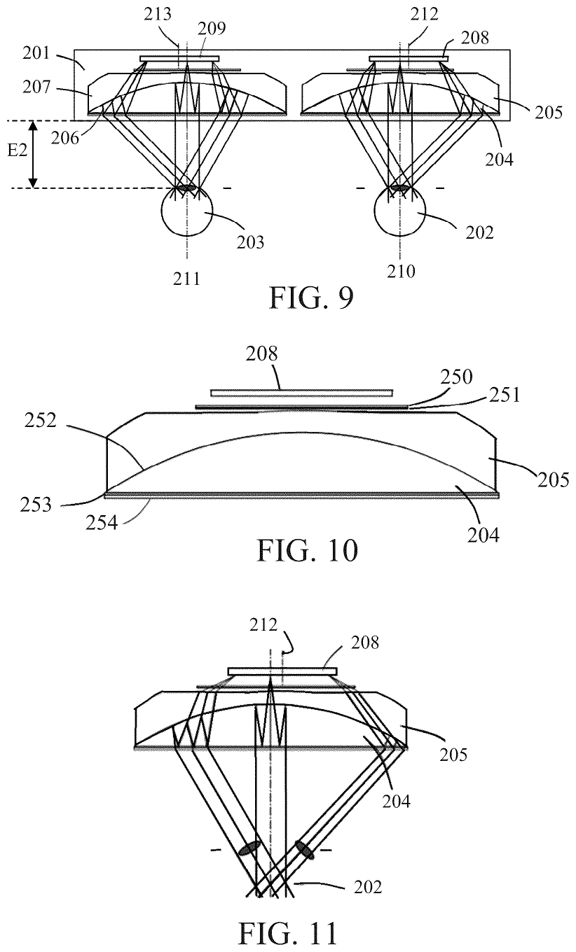

FIG. 9 illustrates the configuration of the HMD 201 according to Example 2. Reference numeral 202 denotes a right eye of the observer, and reference numeral 203 denotes a left eye of the observer. A right-eye display optical system includes a cemented lens of lenses 204 and 205. A left-eye display optical system includes a cemented lens of lenses 206 and 207. Reference numeral 208 denotes a right-eye display element, and reference numeral 209 denotes a left-eye display element. Each display element is an organic EL display. Reference numeral 210 denotes an optical axis of the right-eye display optical system, and reference numeral 211 denotes an optical axis of the left-eye display optical system. Reference numeral 212 denotes a center of the display surface of the right-eye display element 208, and reference numeral 213 denotes a center of the display surface of the left-eye display element 209.

The right-eye display optical system guides image light from the right-eye display element 208 to the observer's right eye 202 so that the observer can observe as a display image an enlarged virtual image of an original image displayed on the right-eye display element 208. The left-eye display optical system guides image light from the left-eye display element 209 to the observer's left eye 203 so that the observer can observe as a display image an enlarged virtual image of an original image displayed on the left-eye display element 209.

A focal length F2 of each of the right-eye display optical system and the left-eye display optical system is 13 mm, and the size of each of the right-eye display element 208 and left-eye display element 209 is 1 inch. An eye relief E2 of the HMD 201 is 20 mm.

An exit pupil of each display optical system is set at a position of 30 mm, which is the sum of the eye relief of 20 mm and a radius of rotation of the eyeball of 10 mm, and the exit pupil diameter is set to 6 mm. Due to this setting, even in a case where the eyeball rotates to observe up, down, left, and right, image light in that direction enters the eyeball.

The center 212 of the right-eye display element 208 is shifted to the right with respect to a vertical section including the optical axis 210 of the right-eye display optical system. A horizontal display angle of view of the right-eye display optical system is 50° on the right side and 30° on the left side. The center 213 of the left-eye display element 209 is shifted to the left with respect to a vertical section including the optical axis 211 of the left-eye display optical system. A horizontal display angle of view of the left-eye display optical system is 30° on the right side and 50° on the left side. That is, the right-eye display optical system and the left-eye display optical system have different left and right display angles of view with respect to the optical axis.

Therefore, when the observer observes images with both eyes (202 and 203), the angle of view (monocular area) from 50° on the right side to 30° on the right side is observed only with the right eye 102. In addition, the angle of view (binocular area) from 30° on the right side to 30° on the left side is observed with both eyes. Moreover, the display angle of view (monocular area) from 30° on the left side to 50° on the left side is observed only with the left eye 203. That is, the entire horizontal display angle of view is 100°. Thus, in this example, images with different display angles of view are displayed for the right eye 202 and left eye 203, and parts of these display angles of view overlap each other and are displayed for both eyes. Thereby, in a case where the right-eye and left-eye display elements 208 and 209 have the same sizes, the observer can observe images at wider angles of view than those in a case where images with the same display angle of view are displayed for the right eye 202 and the left eye 203. The vertical display angle of view of each display optical system is 60°.

Similarly to Example 1, in a case where images with different display angles of view are displayed for the right and left eyes and parts of the display angles of view (binocular area) are displayed for both eyes for a wider angle of view, the display angle of view displayed for both eyes may be 40° or more, or 50° or more. The display angle of view displayed for both eyes of 50° or more can provide a wide three-dimensionally observable range and enables a more natural image to be observed.

The display optical system according to this example is configured to fold the optical path using polarization. Referring now to FIG. 10, a description will be given of its configuration using a right-eye display optical system as an example. As illustrated in FIG. 10, a polarizing plate 250 and a first phase plate (or first waveplate) 251 are disposed between the right-eye display element 208 and the lens 205 in order from the display element side to the observation side (eyeball side). A half-mirror 252 as a half-transmissive reflective surface is formed by vapor deposition on the cemented surface of the lens 204 with the lens 205. Between the lens 204 and the right eye 202, a second phase plate (or second waveplate) 253 and a polarizing beam splitter (PBS) 254 are disposed in order from the display element side. Each of the second phase plate 253 and PBS 254 has a plane shape. The first phase plate 251 and the second phase plate 253 are quarter waveplates (λ/4 plates).

Relative to a polarization direction of linearly polarized light that transmits through the polarizing plate 250, a slow axis of the first phase plate 251 is tilted by 45°, and a slow axis of the second phase plate 253 is tilted by −45°. The polarization direction of the linearly polarized light that transmits through the polarizing plate 250 and the polarization direction of the linearly polarized light that transmits through the PBS 254 are orthogonal to each other.

In such a configuration, unpolarized light emitted from the right-eye display element 208 transmits through the polarizing plate 250 and becomes linearly polarized light, and the linearly polarized light transmits through the first phase plate 251 and is converted into circularly polarized light. The circularly polarized light transmits through the half-mirror 252, transmits through the second phase plate 253, and is converted into linearly polarized light. Since the polarization direction of this linearly polarized light is orthogonal to the polarization direction transmitting through the PBS 254, the linearly polarized light is reflected by the PBS 254, transmits through the second phase plate 253, and is converted into circularly polarized light.

This circularly polarized light is then reflected by the half-mirror 252, transmits through the second phase plate 253, and is converted into linearly polarized light. This linearly polarized light transmits through the PBS 254 and is guided to the right eye 202 because its polarization direction coincides with the polarization direction transmitting through the PBS 254. A polarizing plate (polarizer) may be placed between the PBS 254 and the right eye 202 in order to reduce ghost light generated when external light enters the display optical system and enhance the contrast of a displayed image. The above configuration and optical path are similar to those for the left-eye display optical system.

Folding the optical path using polarization as in this example can reduce the thickness and the focal length of the display optical system, and enables images to be observed at a wide angle of view.

Since the HMD 201 is a head mount type image display apparatus, it may have a reduced weight. Thus, the lenses in the display optical system may be made of resin, which has a lower specific gravity than that of glass. In this example as well, the lenses 204, 205, 206, and 207 may be made of resin and have aspheric surfaces to enhance the aberration correction effect.

Similarly to Example 1, the display optical system according to this example also has a large exit angle of image light from the peripheral area of the display element, and causes a decrease in an angle-of-field characteristic (luminance decrease and chromaticity shift increase).

In the display optical system according to this example, as illustrated in FIG. 9, while the observer is looking at the front, the exit angle of the principal ray from the display element with a maximum peripheral angle of view of 50° in the horizontal direction is 40°, and the exit angle of the principal ray at an angle of view of 30° is 20°. In addition, as illustrated in FIG. 11, while the observer is looking at the end in the horizontal direction, the exit angle of the principal ray from the display element with a maximum peripheral angle of view of 50° in the horizontal direction is 60°, and the exit angle of the principal ray at an angle of view of 30° is 45°.

At this time, the angle-of-field characteristic of the luminance (brightness) and chromaticity shift (ΔE) of a normal display element is as illustrated in FIG. 4. As the exit angle from the display element increases, the luminance decreases and the chromaticity shift increases.

Accordingly, this example as well shifts the color filter position relative to the pixel in the peripheral area of the display element by changing the pixel pitch of the display element and the pitch of the color filters provided for each pixel using the intersection of the display surface of the display element and the optical axis of the display optical system as a center. Thereby, the angle-of-field characteristic can be improved. At this time, in the peripheral area, since the image light is emitted outward from the optical axis of the display optical system, the color filter pitch is set larger than the pixel pitch.

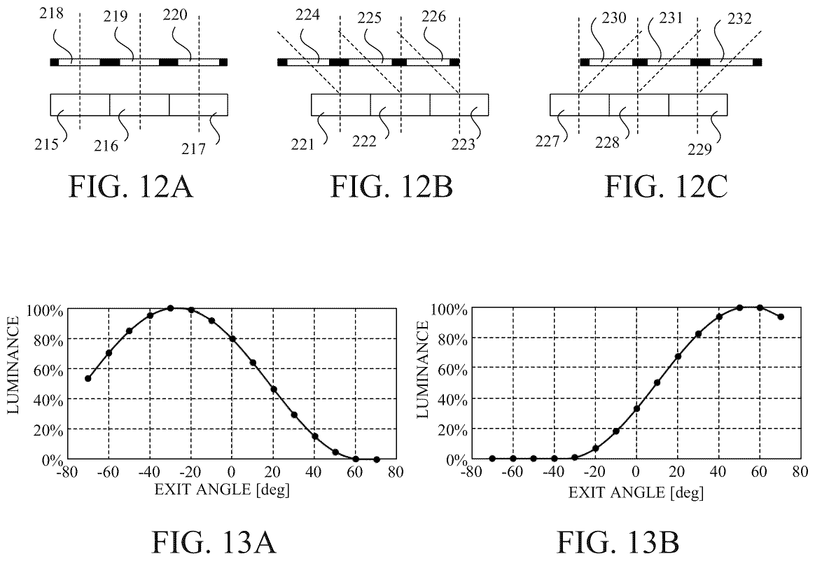

FIGS. 12A to 12C illustrate a positional relationship between the red, green, and blue subpixels provided on the display surface of the right-eye display element 208 and red, green, and blue color filters. Each color filter may be rectangular, square, or hexagonal when viewed from the optical axis direction of the right-eye display optical system.

FIG. 12A illustrates the positional relationship at the intersection between the display surface of the right-eye display element 208 and the optical axis 210 of the right-eye display optical system. At (the intersection area including) the intersection, the centers of the red, green, and blue color filters 218, 219, and 220 coincide with the centers of the red, green, and blue subpixels 215, 216, and 217, respectively, as in a normal display element. FIG. 12B illustrates the positional relationship at the left end of the display surface of the right-eye display element 208 when viewed from the observer. At the left end, the centers of the red, green, and blue color filters 224, 225, and 226 are shifted outward (towards the left eye side) by 27° from the centers of the red, green, and blue subpixels 221, 222, and 223, respectively. FIG. 12C illustrates the positional relationship at the right end of the display surface of the right-eye display element 208 when viewed from the observer. At the right end, the centers of the red, green, and blue color filters 230, 231, and 232 are shifted outward (opposite to the left eye side) by 55° from the centers of the red, green, and blue subpixels 227, 228, and 229, respectively.

Even in this example, an array of color filters relative to an array of pixels on the display element when viewed from the optical axis direction illustrated in FIG. 16A is as illustrated in FIG. 16B.

At this time, the angle-of-field characteristic of the luminance at the left end of the right-eye display element 208 is as illustrated in FIG. 13A, in which the highest luminance is obtained in the −27° direction. Regarding the angle-of-field characteristic of chromaticity shift, the highest characteristic is similarly obtained in the −27° direction.

The exit angle of the principal ray from the left end of the right-eye display element 208 to the right-eye display optical system is −20° while the observer is looking at the front, and −45° while the observer is looking at the left end. At the left end of the displayed image while the observer is looking at the front, unless the color filter is shifted relative to the pixel, the luminance decreases by 12% and ΔE becomes 4 as illustrated at −20° in FIGS. 4A and 4B, respectively. On the other hand, in a case where the color filter is shifted relative to the pixel, the luminance improves because luminance decreases only by 1%, as illustrated at −20° in FIG. 13A, and ΔE because it is also less than 1, although it is not illustrated. While the observer is looking at the left end, at the left of the displayed image, unless the color filter is shifted relative to the pixel, the luminance decreases by 50%, as illustrated at −45° in FIGS. 4A and 4B, and ΔE becomes 16. On the other hand, in a case where the color filter is shifted relative to the pixel, the luminance improves because the luminance decreases only by 10%, as illustrated at −45° in FIG. 13A, and ΔE also improves to 3, although it is not illustrated.

The angle-of-field characteristic of the luminance at the right end of the right-eye display element 208 when viewed from the observer is as illustrated in FIG. 13B, in which the highest luminance is obtained in the 55° direction. Regarding the angle-of-field characteristic of the chromaticity shift, the highest characteristic is similarly obtained in the 55° direction.

The exit angle of the principal ray from the right end of the right-eye display element 208 to the right-eye display optical system is 40° while the observer is looking at the front, and 60° while the observer is looking at the right end.

At the right end of the displayed image while the observer is looking at the front, unless the color filter is shifted relative to the image, the luminance decreases by 41% and ΔE becomes 13 as illustrated at 40° in FIGS. 4A and 4B, respectively. On the other hand, in a case where the color filter is shifted relative to the image, the luminance improves because the luminance decreases only by 7% as illustrated at 40° in FIG. 13B, and ΔE also improves to 2, although it is not illustrated. In addition, at the right end of the displayed image while the observer is looking at the right end, unless the color filter is shifted relative to the pixel, the luminance decreases by 75% and ΔE becomes 25, as illustrated at 60° in FIGS. 4A and 4B. On the other hand, in a case where the color filter is shifted relative to the pixel, the luminance improves because the luminance decreases only by 1%, as illustrated at 60° in FIG. 13B, and ΔE improves to less than 1, although it is not illustrated.

While the color filter shift at the left and right ends in the horizontal direction of the display element has been described, this is similarly applicable to the upper and lower ends in the vertical direction. In the display optical system according to this example, while the observer is looking at the front, the exit angle of the principal ray from the display element with a maximum peripheral angle of view in the vertical direction of 30° is 20°. While the observer is looking at the end in the vertical direction, the exit angle of the principal ray from the display element with a maximum peripheral angle of view in the vertical direction of 30° is 45°.

At the upper end of the right-eye display element 208 when viewed from the observer, the center of the red color filter is placed at a position shifted upward by 27° from the center of the red subpixel. At the lower end of the right-eye display element 208, the center of the red color filter is placed at a position shifted downward by 27° from the center of the red subpixel. This is similarly applicable to the green color filter and the blue color filter.

Shifting the color filter from the pixel as described above can improve luminance and chromaticity shift at the upper and lower ends of the right-eye display element 208.

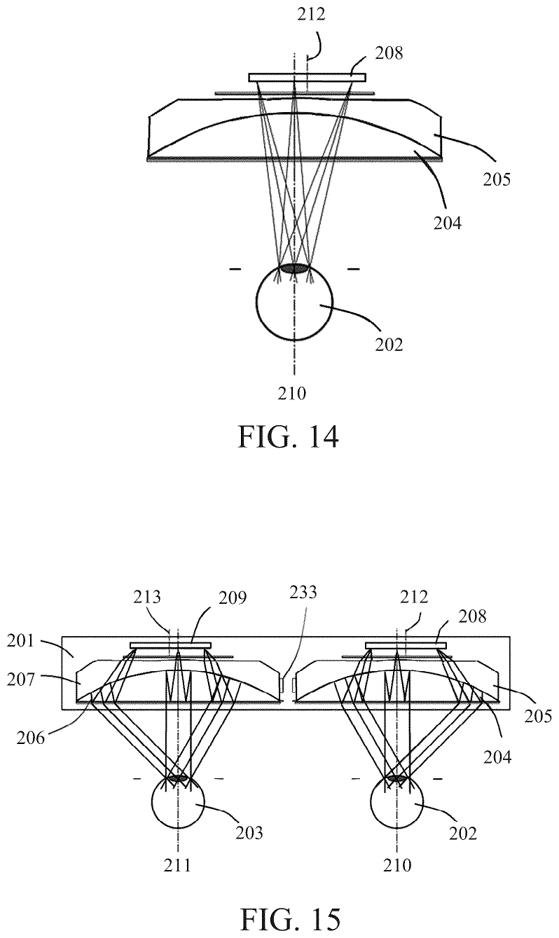

In the display optical system according to this example, due to the birefringence of the lenses 204 and 205 and the polarization characteristics of the polarizing plate 250, the phase plates 251 and 253, and the PBS 254, not only the normal light illustrated in FIG. 9 but also ghost light, which is unnecessary light that is not reflected on the PBS 254 as illustrated in FIG. 14 and is guided to the observer's eyes, may occur. This ghost light occurs, after the circularly polarized light transmits through the first phase plate 251, becomes elliptically polarized light due to birefringence within the lenses 205 and 204, so that the polarization direction of the linearly polarized light that transmits through the second phase plate 253 is tilted, and light in the polarization direction that transmits through the PBS 254 is guided to the right eye 202. Even if the lens has no birefringence, ghost light is generated if the polarization characteristics of the polarizing plate 250, phase plates 251 and 253, and PBS 254 are not so good. This is similarly applicable to the left-eye display optical system.

As understood from FIG. 14, the exit angle of the principal ray of the ghost light from the end in the horizontal direction of the right-eye display element 208 while the observer is looking at the front is 15°, which is tilted to the opposite side to the normal of the right-eye display element 208, relative to the exit angle of the principal ray of the normal light in FIG. 9. Therefore, in improving the angle-of-field characteristic of the luminance and chromaticity shift by shifting the color filter relative to the pixel according to the exit angle of the principal ray of the normal light as in this example, the luminance of the ghost light from the peripheral area of the right-eye display element 208 can be reduced.

Since the birefringence of a lens generally increases from the center of the lens to the peripheral area, the intensity of ghost light caused by the birefringence of the lens also increases from the center to the peripheral area. Therefore, in order to reduce ghost light passing through the peripheral area of the lens, it is effective to lower the brightness of the light from the peripheral area of the right-eye display element 208. More specifically, if the color filter is not shifted, the luminance of the ghost light from the end in the horizontal direction of the right-eye display element 208 is 93%, whereas if the color filter is shifted, the luminance of the ghost light can be significantly reduced by 12%. This is similarly applicable to the vertical direction.

In this example, an angle φ for shifting the color filter outward at the end in the horizontal direction at the display angle of view 50° of the display element is 55°, and the angle-of-field characteristic in this direction is better than that in the normal direction. θ1 in inequalities (1) and (2) at an angle of view of 50° is 60°, θ2 in inequality (2) is 40°, and the angle φ for shifting the color filter outward satisfies inequalities (1) and (2).

An angle φ for shifting the color filter outward at the ends in the horizontal and vertical directions at a display angle of view of 30° is 27°, and the angle-of-field characteristic in this direction is better than that in the normal direction. At a display angle of view 30°, θ1 is 45° and θ2 is 20°, and the angle q for shifting the color filter outward satisfies inequalities (1) and (2).

In a case where a display angle of view is 50° as in this example, the display angle of view is wide and the observer has difficulty in recognizing an image in the peripheral area while looking at the front. Thus, an angle for shifting the color filter outward may be determined based on the exit angle of the principal ray from the display element in a certain direction while the observer is looking at that direction, rather than while the observer is looking at the front.

The following inequality (3) may be satisfied:

$$15 ° \leq \vert φmax - θ3 \vert \qquad ( 3 )$$

where φmax is an angle for shifting the color filter outward at the end in the horizontal direction of the display element, and θ3 is an exit angle of a principal ray of ghost light (unnecessary light) from the end in the horizontal direction of the display element while the observer is looking at the front. A direction toward the outside of the display element is set positive, and a direction toward the center is set negative. In this example, φmax is 55° and θ3 is −15°, and this example satisfies inequality (3). In a case where |φmax−θ3| is less than 15°, an exit angle of ghost light from the display element and a direction in which the angle-of-field characteristic is good are close to each other, and the ghost light intensity increases.

In this example, the color filter has a function of controlling an exit angle of image light emitted from the display element, improves the angle-of-field characteristic of the luminance and chromaticity shift in the peripheral area, and reduces ghost light.

In addition, this example sets, to a large angle of 55°, an angle for shifting the color filter outward at the end in the horizontal direction at the display angle of view 50° by giving priority to the observer observing left and right sides and by reducing ghost light. However, depending on the use case of the HMD, improving the angle-of-field characteristic in the peripheral area may be sought while the observer is looking at the front, even if the display angle of view is large. In this case, the angle for shifting the color filter outward at the end in the horizontal direction of the display angle of view 50° may be adjusted to the exit angle of 40° of the principal ray from the display element at the maximum peripheral angle of view of 50° in the horizontal direction while the observer is looking at the front. Moreover, the angle for shifting the color filter may be set to 50°, which is an average of the exit angle of 40° of the principal ray from the display element at the maximum peripheral angle of view of 50° in the horizontal direction while the observer is looking at the front and the exit angle of 60° of the principal ray from the display element at the maximum peripheral angle of view of 50° in the horizontal direction while the observer is looking at the end in the horizontal direction.

As described above, in this example, the color filter has a function of controlling the exit angle, but the exit angle may be controlled using a microlens as an optical element provided for each pixel. Even in this case, similarly to the color filter, an angle (shift amount) for shifting the center of the microlens outward relative to the center of the pixel is made larger in the peripheral area than that in the intersection area on the display surface of the display element.

In this example, a surface on which the half-mirror 252 is deposited is a lens surface that is convex toward the right-eye display element 208. Depositing a half-mirror 252 on this convex surface can reduce the thickness of the display optical system and increase an angle of view. Making the convex surface on which the half-mirror 252 is deposited an aspherical shape can enhance the aberration correction effect.

In this example, a surface on the observation side of the lens 204, on which the second phase plate 253 and PBS 254 are formed is a flat surface. This is to increase the eye relief and to reduce the thickness of the display optical system. Therefore, the lens 204 is a plano-convex lens.

In this example, a phase difference between the first and second phase plates 251 and 253 is λ/4, but a phase difference may be shifted from λ/4 so as to cancel the birefringence of the lenses 204 and 205. At this time, the sum of phase differences of the lens 204 and the second phase plate 253 may be 3λ/20 or more and 7λ/20 or less. The sum of phase differences of the lens 205 and the first phase plate 251 may be 3λ/20 or more and 7λ/20 or less. In a case where the value becomes outside this range, the ghost light intensity increases and a natural image cannot be observed.

In resin lenses injection molded like the lenses 204 to 207 in this example, birefringence becomes large near a molding gate mark. In a case where birefringence is large, ghost light occurs or a light amount decreases. Thus, as illustrated in FIG. 15, molding gate marks 233 of the lenses 205 and 207 may be disposed on the observer's nose side. In this example, a display angle of view is wider on the ear side than that on the nose side of the observer, and a ray effective area of the lens on the ear side is also wider than that on the nose side. Therefore, placing the molding gate mark on the nose side where the ray effective area is narrow can reduce ghost light and a light intensity decrease caused by large birefringence. Similarly, the molding gate marks on the lenses 204 and 206 may be on the observer's nose side.

In this example, the display element includes an organic EL display that emits unpolarized light, but it may include a liquid crystal display element that emits linearly polarized light. In this case, the polarizing plate 250 on the display element side is unnecessary, and the thickness of the display optical system can be further reduced.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide an image display apparatus that has a reduced thickness and a wide angle of view, and can reduce luminance decrease and chromaticity shift of light from a peripheral area of a display element.

This application claims priority to Japanese Patent Application No. 2023-126004, which was filed on Aug. 2, 2023, and which is hereby incorporated by reference herein in its entirety.

What is claimed is:

1. An image display apparatus comprising:
a right-eye display element and a left-eye display element, each of which has a plurality of pixels on a display surface;
a right-eye display optical system configured to guide image light from the right-eye display element to a right eye of an observer; and
a left-eye display optical system configured to guide image light from the left-eye display element to a left eye of the observer,
wherein each of the right-eye display element and the left-eye display element includes an element that is at least one of a color filter and a microlens provided corresponding to each of the plurality of pixels,
wherein an intersection of an optical axis of the right-eye display optical system and the display surface of the right-eye display element shifts from a center of the display surface of the right-eye display element,
wherein an intersection of an optical axis of the left-eye display optical system and the display surface of the left-eye display element shifts from a center of the display surface of the left-eye display element, and
wherein in a case where an area including the intersection is set to an intersection area and an area on a peripheral side of the intersection area is set to a peripheral area, in each of the right-eye display element and the left-eye display element, a shift amount toward a peripheral side of a center of the element corresponding to the pixel from a center of the pixel in the peripheral area is larger than that in the intersection area.

2. The image display apparatus according to claim 1, wherein in each of the right-eye display element and the left-eye display element, a pitch between adjacent elements in the peripheral area is larger than that in the intersection area.

3. The image display apparatus according to claim 1, wherein in each of the right-eye display element and the left-eye display element, the center of the pixel and the center of the element coincide in the intersection area.

4. The image display apparatus according to claim 1, wherein the shift amount increases from a portion on an intersection side to a portion on the peripheral side in the peripheral area.

5. The image display apparatus according to claim 4, wherein a size of the element increases from the portion on the intersection side to the portion on the peripheral side in the peripheral area.

6. The image display apparatus according to claim 1, wherein a display angle of view formed by each of the right-eye display optical system and the left-eye display optical system includes a binocular area for displaying an image to be observed with both eyes of the observer, and a monocular area for displaying an images to be observed by one of the right eye and the left eye, and
wherein the shift amount in the monocular area is larger than that in the binocular area.

7. The image display apparatus according to claim 6, wherein the display angle of view in the monocular area in a lateral direction is 40° or more.

8. The image display apparatus according to claim 1, wherein in a case where an angle-of-field characteristic is defined as at least one of luminance and chromaticity shift according to an exit angle of the image light from the display surface, a high angle-of-field characteristic represents high luminance and small chromaticity shift, and
wherein the angle-of-field characteristic in a normal direction to the display surface at the center of the display surface is higher than that in the normal direction at the intersection.

9. The image display apparatus according to claim 1, wherein in a case where an angle-of-field characteristic is defined as at least one of luminance and chromaticity shift according to an exit angle of the image light from the display surface, a high angle-of-field characteristic represents high luminance and small chromaticity shift,
wherein at the intersection, the angle-of-field characteristic in a normal direction to the display surface is higher than that in a specific direction tilted relative to the normal direction toward the peripheral side, and
wherein at an end of the display surface, the angle-of-field characteristic in the normal direction is lower than that in the specific direction.

10. The image display apparatus according to claim 9, wherein the following inequality is satisfied:
0<φ≤θ1
where φ is a tilt angle in the specific direction relative to the normal direction, and θ1 is an exit angle from the display surface of a principal ray of the image light that travels from the end toward a center of an exit pupil where an eyeball of the observer is disposed while the eyeball faces the end.

11. The image display apparatus according to claim 10, whereas a direction in which each of the optical axis of the right-eye display optical system and the optical axis of the left-eye display optical system extends is defined as an optical axis direction, and
wherein the following inequality is satisfied:
θ2≤φ≤θ1
where θ2 is an exit angle from the display surface of a principal ray of the image light that travels from the end toward the center of the exit pupil while the eyeball faces the optical axis direction.

12. The image display apparatus according to claim 11, wherein each of the right-eye display optical system and the left-eye display optical system includes, in order from a display element side to an observation side, a first phase plate, a half-transmissive reflective surface, a lens, a second phase plate, and a polarizing beam splitter configured to reflect first linearly polarized light and to transmit second linearly polarized light having a polarization direction orthogonal to a polarization direction of the first linearly polarized light,
wherein the image light from the display element side transmits through the half-transmissive reflective surface, is reflected on the polarizing beam splitter, is reflected on the half-transmissive reflective surface, transmits through the polarizing beam splitter, and is guided to the observation side, and
wherein the following inequality is satisfied:
$$15 ° \leq \vert φmax - θ3 \vert$$
where φmax is a tilt angle in the specific direction at the end of the display surface, and θ3 is an exit angle from the display surface of a principal ray that travels from the end toward the center of the exit pupil of unnecessary light from the display element side that transmits through the half-transmissive reflective surface, and transmits through the polarizing beam splitter toward the observation side, while the eyeball faces the optical axis direction.

13. The image display apparatus according to claim 12, wherein the lens is manufactured by injection molding using resin and has a molding gate mark, and
wherein in each of the right-eye display optical system and the left-eye display optical system, the lens is disposed such that the molding gate mark is located on a nose side of the observer.
